(19) United States
(12) Patent Application Publication
(10) Pub. No.: US 2013/0265710 A1
(43) Pub. Date: Oct. 10, 2013

(54) MOTHERBOARD HAVING DISK ON MODULE

(71) Applicants: AN-GANG LIANG, Shenzhen City (CN); PING-CHUAN DENG, Shenzhen City (CN); MING-YU LIU, Shenzhen City (CN)

(72) Inventors: AN-GANG LIANG, Shenzhen City (CN); PING-CHUAN DENG, Shenzhen City (CN); MING-YU LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/559,234

(22) Filed: Jul. 26, 2012

(30) Foreign Application Priority Data
Apr. 6, 2012 (CN) 201210098838.X

(51) Int. Cl. G06F 1/18

(52) U.S. Cl. 361/679.32

(57) ABSTRACT

A motherboard having a disk on module (DOM) module includes a connector arranged on the DOM, two first signal input pins and two first signal output pins connected to a control chip of the DOM, a first power pin connected to a first power unit of the DOM, and four first ground pins grounded. A socket to receive the connector includes two second signal input pins and two second signal output pins connected to a serial advanced technology attachment (SATA) control chip of the motherboard, a second power pin connected to a second power unit of the motherboard, and four second ground pins grounded.

### BACKGROUND

1. Technical Field

The present disclosure relates to a motherboard having a disk on module (DOM) module.

2. Description of Related Art

At present, a DOM module is mounted on a motherboard using a serial advanced technology attachment (SATA) connector, to expand storage capacity of the motherboard. Some of the DOM module receives SATA signals from the motherboard through the SATA connector and receives voltages through a power interface and a power cable. However, the power cable is thin and easily broken. Therefore, there is room for improvement in the art.

### BRIEF DESCRIPTION OF THE DRAWINGS

Many aspects of the embodiments can be better understood with reference to the following drawings. The components in the drawing are not necessarily drawn to scale, the emphasis instead being placed upon clearly illustrating the principles of the present embodiments.

FIG. 1 is an isometric view of a motherboard having a disk on module (DOM) module in accordance with an exemplary embodiment of the present disclosure.

FIG. 2 is an isometric view of the DOM module of FIG. 1.

FIG. 3 is an isometric view of a connector socket of the motherboard of FIG. 1.

FIG. 4 is another isometric view of the connector socket of FIG. 3.

### DETAILED DESCRIPTION

The disclosure, including the drawings, is illustrated by way of example and not by way of limitation. References to “an” or “one” embodiment in this disclosure are not necessarily to the same embodiment, and such references mean at least one.

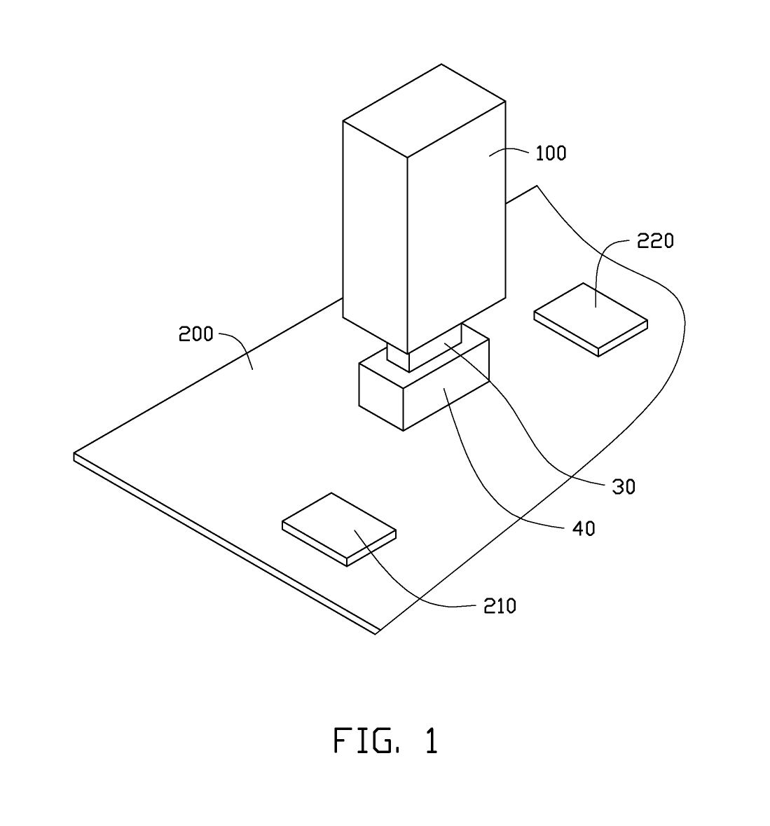

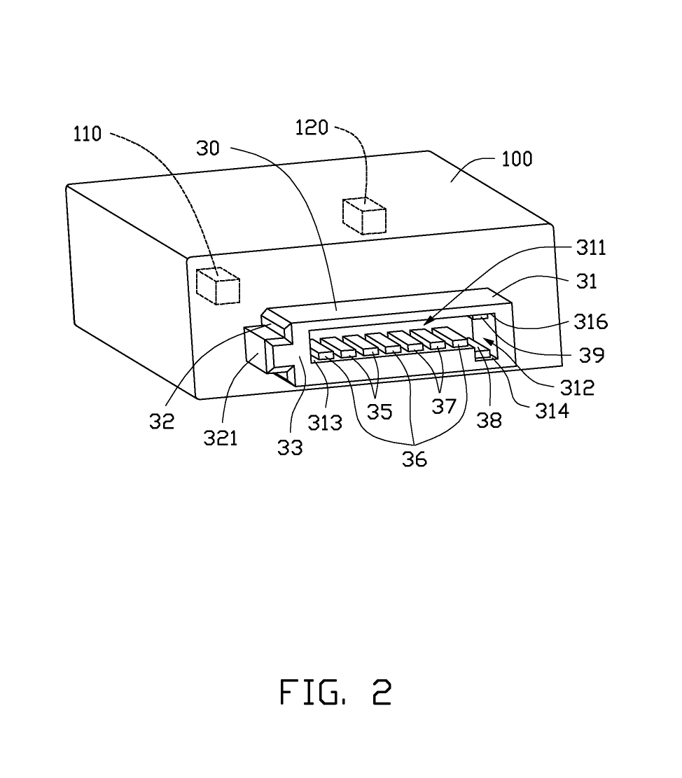

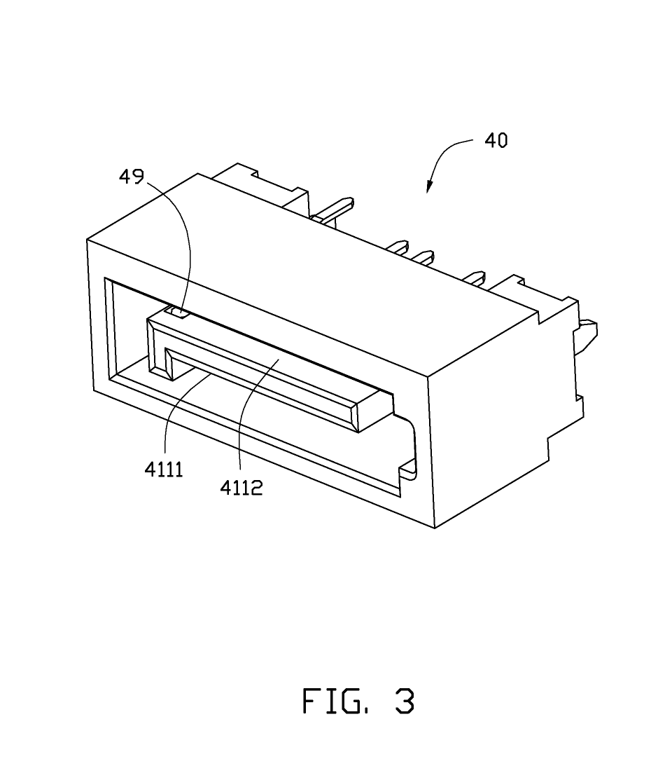

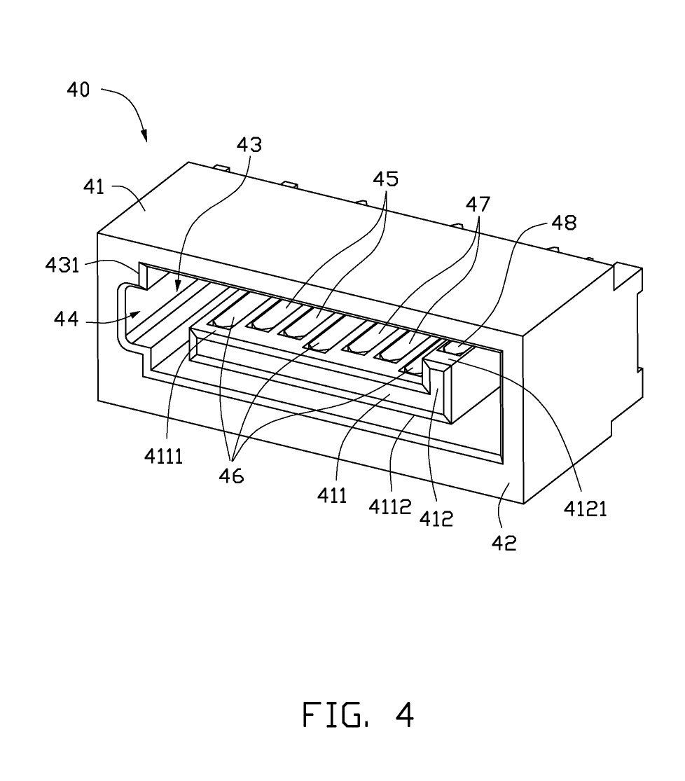

Referring to FIG. 1 to FIG. 4 is a disk on module (DOM) module 100 mounted on a motherboard 200, to expand a storage capacity of the motherboard 200.

A connector 30 is arranged on the DOM module 100. The connector 30 includes a substantially rectangular main body 31. A protrusion 321 is extended from an end wall 32 of the main body 31. A first hole 311 is defined in a sidewall 33 of the main body 31. A second hole 312 is defined in the sidewall 33 of the main body 31 away from the protrusion 321 and communicating with the first hole 311. The second hole 312 has a greater depth than the first hole 311. Three ground pins 36, a pair of signal input pins 35, and a pair of signal output pins 37 are all arranged on a bottom wall 313 and bounded by the sidewalls of the first hole 311. A power pin 38 is arranged on a bottom wall 314 and bounded by the sidewalls of the second hole 312. A ground pin 39 is arranged on a top wall 316 and bounded by the sidewalls of the second hole 312. The signal input pins 35 and the signal output pins 37 are connected to a control chip 110 of the DOM module 100. The power pin 38 is connected to a power unit 120 of the DOM module 100. The ground pins 36 and 39 are grounded. The main body 31 is made of dielectric material.

A serial advanced technology attachment (SATA) control chip 210, a power unit 220, and a socket 40 are all arranged on the motherboard 200. The socket 40 includes a substantially rectangular main body 41. A first opening 43 is defined in a sidewall 42 of the main body 41. A second opening 44 is defined in the sidewall 42 and communicates with an end of the first opening 43. A first board body 411 is formed inside the first opening 43. A second board body 412 is extended upward from an end of the first board body 411 away from the second opening 44. The second board body 412 extends along a height orientation of the first opening 311. Three ground pins 46, a pair of signal input pins 45, and a pair of signal output pins 47 are arranged on a bottom wall 4111 of the first board body 411. A power pin 48 is arranged on a bottom wall 4121 of the second board body 412. A ground pin 49 is arranged on a top wall 4112 of the first board body 411, below the second board body 412 and corresponding to the power pin 48. The signal input pins 45 and the signal output pins 47 are connected to the SATA control chip 210. The power pin 48 is connected to the power unit 220. The ground pins 46 and 49 are grounded. The main body 41 is made of dielectric material.

When the DOM module 100 is mounted on the motherboard 200, and the connector 30 is plugged into the socket 40. The protrusion 321 of the connector 30 engages in the second hole 44 of the socket 40, the first board body 411 engages in the first hole 311, and the second board body 412 engages in the second hole 312. The signal input pins 35, the signal output pins 37, the ground pins 36 and 39, and the power pin 38 are respectively connected to the signal input pins 45, the signal output pins 47, the ground pins 46 and 49, and the power pin 48, to electrically connect the connector 30 to the socket 40. The motherboard 200 communicates with the DOM module 100 through the signal input pins 35 and 45 and the signal output pins 45 and 47, for transmitting the SATA signals. The DOM 100 receives voltages from the motherboard 200 through the power pins 38 and 48, and the ground pins 39 and 49.

The motherboard 200 can receive SATA signals and voltages through the connector 30 and the socket 40, to avoid using a power cable when the DOM module 100 is mounted on the motherboard 200.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A motherboard comprising:
a disk on module (DOM) module comprising a control chip, a first power unit, and a connector, and the connector comprising a first main body, wherein first main body comprises two first signal input pins, two first signal output pins, a first power pin, and four first ground pins, the first signal input pins and the first signal output pins are connected to the control chip, the first power pin is connected to the first power unit, the first ground pins are grounded;
a serial advanced technology attachment (SATA) control chip arranged on the motherboard;
a second power unit arranged on the motherboard; and
a socket arranged on the motherboard and comprising a second main body, wherein the second main body comprises two second signal input pins, two second signal output pins, a second power pin, and four second ground pins, the second signal input pins and the second signal output pins are connected to the SATA control chip, the second power pin is connected to the second power unit, the second ground pins are grounded;
wherein the first signal input pins, the first signal output pins, the first power pin, and the first ground pins are electrically connected to the second signal input pins, the second signal output pins, the second power pin, and the second ground pins, in response to the connector being plugged into the socket.

2. The motherboard of claim 1, wherein a protrusion is extended from an end wall of the first main body, a first opening and a second opening are defined in the second main body, the second opening is extended from an end of the first opening and detachably receives the protrusion.

3. The motherboard of claim 2, wherein a first hole is defined in the first main body, a second hole is defined in the first main body away from the protrusion and communicating with the first hole, the second hole is extended downward along a height orientation of the main body, a first board body is formed inside the first opening and engages in the first hole, a second board body is extended upward from an end of the first board body and away from the second opening, the second board body engages in the second hole, the first signal input pins, the first signal output pins, and three first ground pins are arranged on a bottom wall of the first hole, the first power pin and one first ground pin are respectively arranged on a top wall and a bottom wall of the second hole, the second signal input pins, the second signal output pins, the second power pin, and three second ground pins are arranged on a bottom wall of the first board body, the second power pin is arranged on a bottom wall of the second board body, one ground pin is arranged on a top wall of the first board body and corresponding to the second power pin.

4. The motherboard of claim 1, wherein the first and second main bodies are made of a dielectric material.
